(19) United States
(12) Patent Application Publication
(10) Pub. No.: US 2017/0089056 A1
(43) Pub. Date: Mar. 30, 2017

(54) Long Pond Water Management System

(71) Applicant: Charlie J. Schafer, St. Petersburg, FL (US)

(72) Inventor: Charlie J. Schafer, St. Petersburg, FL (US)

(21) Appl. No.: 14/864,155

(22) Filed: Sep. 24, 2015

(51) Int. Cl. E03F 5/10; A01G 25/00; E03F 1/00

(52) U.S. Cl. CPC E03F 5/103; E03F 1/001; A01G 25/00

(57) ABSTRACT

Disclosed is a system for managing water. In example embodiments, the system may include a long pond for storing water. In some embodiments the long pond may be used to prevent flooding, in other examples the long pond may be used as a reservoir for holding water usable with irrigation and sub-irrigation systems.

### BACKGROUND

1. Field

Example embodiments relate to systems for managing water. In example embodiments, the systems may include a long pond for storing water. In some embodiments the long pond may be used to prevent flooding, in other examples the long pond may be used as a reservoir for holding water usable with irrigation and sub-irrigation systems. In some embodiments the systems improve both wildlife habitat and water quality.

2. Description of the Related Art

FIG. 1 is a schematic view of a farm field 10 in which rows of plants 15 are grown. On many farms runoff from rain flows across the ground and into a surface water 30 (e.g. a river, lake, stream, and/or drainage ditch). Because runoff often contains sediments, nutrients, pesticides, and other pollutants, many farmers provide buffer strips 20 between the farmland and the surface water 30. A buffer strip 20 is an area of land having vegetation (for example, grass, trees, and/or shrubs) thereon. This area helps trap and filter the sediments, nutrients, pesticides, and other pollutants. As such, the runoff is somewhat cleaned before it enters the surface water 30.

Often times, for example, during a heavy rain, the surface water 30 floods and washes over the buffer strips 20 and into the fields 10. Such an event may cause damage to crops which could be catastrophic to a farmer.

### SUMMARY

The inventor set out to solve a problem associated with managing water to reduce flooding. As a result, the inventor developed a new system for protecting fields against flooding and drought. However, the inventor has also found several other uses for his invention which are novel and nonobvious. Such uses include, but are not limited to, creating a reservoir for water usable in surface and subsurface irrigation. The invention is also usable for not only preventing local flooding, but for preventing flooding at a location remote from a farm. The invention also provides for robust and resilient agricultural production systems well suited to withstand the variability of climate change. Example embodiments also provide for improved water quality and improved wildlife habitats.

Example embodiments provide a system for managing water, the system including a long pond, or a series of long ponds, having a means to receive water from a drainage ditch.

### BRIEF DESCRIPTION OF THE DRAWINGS

Example embodiments are described in detail below with reference to the attached drawing figures, wherein:

FIG. 1 is a view of a conventional farm field, buffer strip, and surface water;

FIG. 2 is a view of a system comprised of a long pond in accordance with example embodiments;

FIG. 3A is a view of a buffer, a long pond, and a ditch in accordance with example embodiments;

FIG. 3B is a section view of the long pond and the ditch in accordance with example embodiments;

FIG. 3C is another section view of the long pond and the ditch in accordance with example embodiments;

FIG. 4 is a section view of a long pond and a ditch holding water in accordance with example embodiments;

FIG. 5A is a view of a buffer, a long pond, and a ditch in accordance with example embodiments;

FIG. 5B is a section view of the long pond and the ditch in accordance with example embodiments;

FIG. 5C is another section view of the long pond and the ditch in accordance with example embodiments;

FIG. 6A is a view of a control station in accordance with example embodiments;

FIG. 6B is a view of a control station in accordance with example embodiments;

FIG. 6C is a view of a control station in accordance with example embodiments;

FIG. 7A is a section view of the long pond and the ditch in accordance with example embodiments;

FIG. 7B is another section view of the long pond and the ditch in accordance with example embodiments;

FIG. 7C is a section view of the long pond and the ditch in accordance with example embodiments;

FIG. 8 is a section view of the long pond and the ditch in accordance with example embodiments;

FIG. 9A is a view of a layout of farms in accordance with the conventional art;

FIG. 9B is a view of a layout of farms in accordance with example embodiments;

FIG. 10 is a system view of a control stations in accordance with example embodiments;

FIG. 11 is a view of a system having passages, control stations, and sensors;

FIG. 12A is a view of a system in accordance with example embodiments;

FIG. 12B is a partial view of a system in accordance with example embodiments;

FIG. 13A is a cross-section view of a system in accordance with example embodiments;

FIG. 13B is a cross-section view of a system in accordance with example embodiments;

FIG. 14A is a cross-section view of a system in accordance with example embodiments;

FIG. 14B is a cross-section view of a system in accordance with example embodiments;

FIG. 14C is a cross-section view of a system in accordance with example embodiments;

FIG. 15 is a cross-section view of a system in accordance with example embodiments;

FIG. 16A is a view of a system in accordance with example embodiments;

FIG. 16B view is a partial view of a system in accordance with example embodiments;

FIG. 16C is a cross-section of a system in accordance with example embodiments; and

FIG. 16D is a cross-section of a system in accordance with example embodiments.

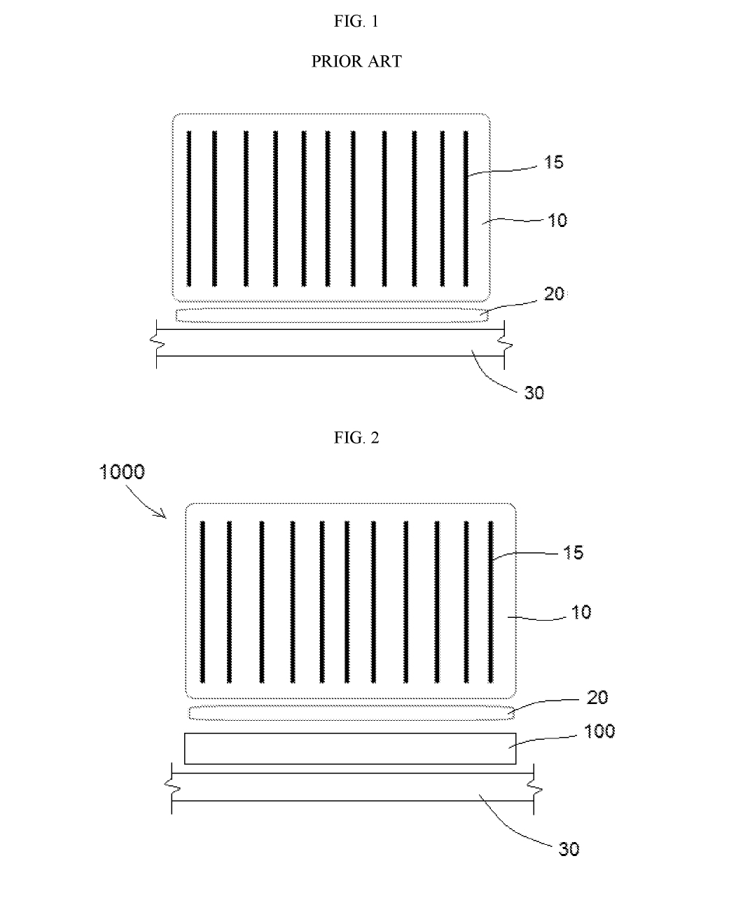

### DETAILED DESCRIPTION

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a system for managing water. In example embodiments, the system may include a long pond for storing water. In some embodiments the long pond may be used to prevent flooding, in other examples the long pond may be used as a reservoir for holding water usable with irrigation and sub-irrigation systems.

FIG. 2 is a view of a system 1000 in accordance with example embodiments. As shown in FIG. 2, the system 1000 includes a farm field 10, a buffer strip 20, a long pond 100, and a drainage ditch 30. In the example embodiment of FIG. 2, the long pond 100 is arranged between the buffer strip 20 and the drainage ditch 30. In example embodiments the presence of a buffer strip 20 is desirable, however it is not required in the system 1000. As such, the buffer strip 20 may be omitted from the system 1000 without departing from the inventive concepts disclosed herein. Furthermore, although the invention disclosed herein was inspired by the agricultural industry, the invention is not limited thereto. As such, the inventive concepts may be applied outside the field of agriculture. Accordingly, the farm field 10 is also not necessary and may be omitted from the system 1000. Regardless, in example embodiments, the field 10, the buffer strip 20, and the drainage ditch 30 may be conventional, as such, a detailed description thereof is omitted for the sake of brevity.

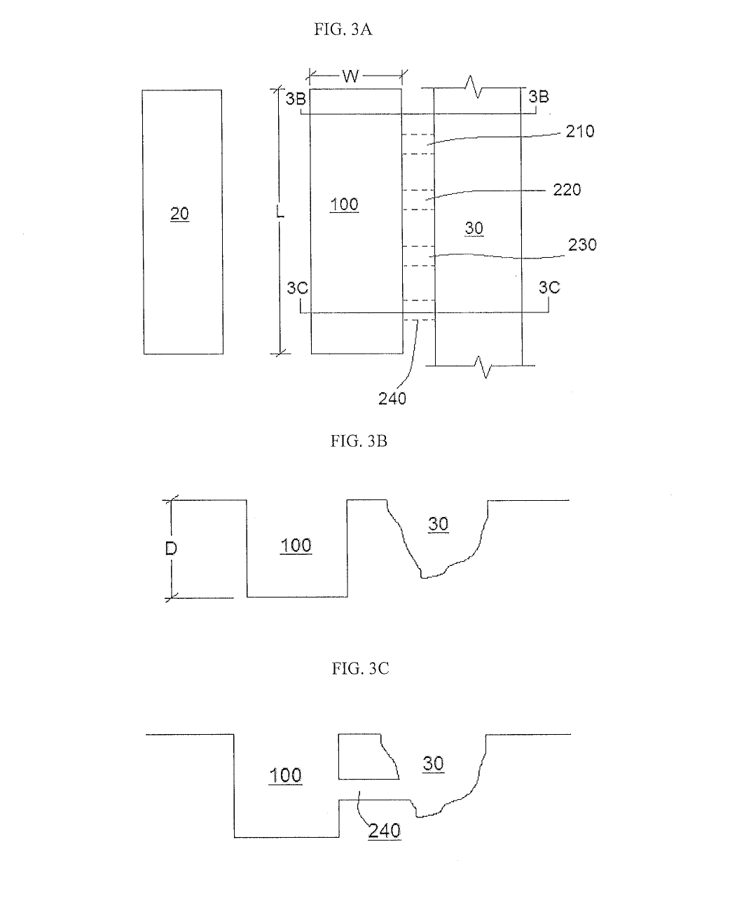

FIGS. 3A-3C illustrate a portion of the system 1000. In particular, FIGS. 3A-3C focus on system 1000′s buffer strip 20, long pond 100, and drainage ditch 30. FIG. 3A, for example shows a top view of the buffer strip 20, the long pond 100, and the drainage ditch 30. FIG. 3B illustrates a cross-section view of the long pond 100 and the drainage ditch 30 taken through line 3B-3B of FIG. 3A and FIG. 3C illustrates a cross-section view of the long pond 100 and the drainage ditch 30 taken through line 3C-3C of FIG. 3A.

In example embodiments, the long pond 100 may be formed in the ground by a conventional excavating method. In one particular nonlimiting example embodiment, a length L of the long pond 100 may be about one thousand feet, a width W of the long pond 100 may be about one hundred feet, and a depth D of the long pond 100 may be about ten feet. In this particular nonlimiting example embodiment, the capacity of the long pond 100 would be about one million cubic feet of water. The long pond 100, however, is not required to have the above dimension and may be longer or shorter, wider or narrower, deeper or shallower. For example, the length of the long pond 100 may only be five hundred feet or two hundred and fifty feet.

Between the long pond 100 and the drainage ditch 30 are a plurality of passages that may allow water to flow from the long pond 100 to the drainage ditch 30 or from the drainage ditch 30 to the long pond 100. For example, the plurality of passages may include a first passage 210, a second passage 220, a third passage 230, and a fourth passage 240. The passages 210, 220, 230, and 240 may be, but are not required to be, pipes that extend between the long pond 100 and the drainage ditch 30. The pipes, for example, may be eight inch diameter pipes, ten inch diameter pipes, twelve inches diameter pipes or fourteen inch diameter pipes. However, the particular size of the pipes is relatively unimportant as the pipes may be smaller than eight inches or larger than eight inches. Furthermore, the passages may be formed by some other structure than a pipe, for example, square tubing. Further yet, the passages may be configured in a manner that mimics what is commonly referred to as a French drain. Regardless, in example embodiments the plurality of passages provides for fluid communication between the long pond 100 and the ditch 30 and thus serves as a means for which the long pond 100 may receive water from the drainage ditch 30 or the drainage ditch 30 may receive water from the long pond 100.

In example embodiments the first, second, third, and fourth passages 210, 220, 230, and 240 may be equally spaced. For example, if the long pond 100 had a length of one thousand feet, the first, second, third, and fourth passages 210, 220, 230, and 240 may be spaced apart from each other by about two hundred feet. However, the spacing and number of the passages is not critical as there may be more than four passages or less than four passages connecting the long pond 100 to the drainage ditch 30. Furthermore, the passages are not required to be equally spaced.

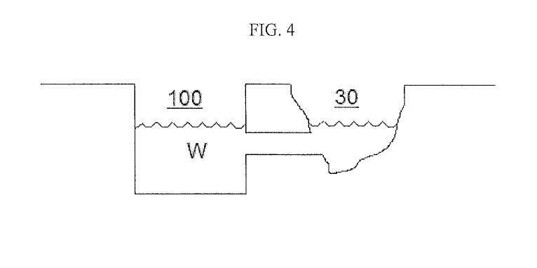

FIG. 4 illustrates a cross-section of the long pond 100 and the drainage ditch 30 with water W residing in the long pond 100 and the ditch 30. As shown in FIG. 4, the water level in the long pond 100 and the ditch 30 may be about the same in the event water W is allowed to freely flow from the ditch 30 to the long pond 100 or from the long pond 100 to the drainage ditch 30.

Referring to FIGS. 2 and 4, any water not absorbed by the field 10 (for example, during a heavy rain) may flow along the field 10 as surface water to the buffer strip 20. At the buffer strip 20 the surface water may be “cleaned” by various plants that may be in the buffer strip 20 and the “cleaned” water thereafter may flow into the long pond 100. Because the system 1000 may include passages from the long pond 100 to the ditch (for example, passages 210, 220, 230, and 240), water in the long pond 100 may flow into the drainage ditch 30 via the plurality of passages. The water flowing into the drainage ditch 30 may then be carried away by gravity.

In example embodiments, the water in the long pond 100 may be relatively clean since the water flowing into the long pond 100 may be filtered by a buffer strip 20. Given that the size of a long pond may be relatively large, the long pond 100 may serve as a relatively healthy source of water for wildlife. Thus, the long ponds 100 may improve wildlife habitat.

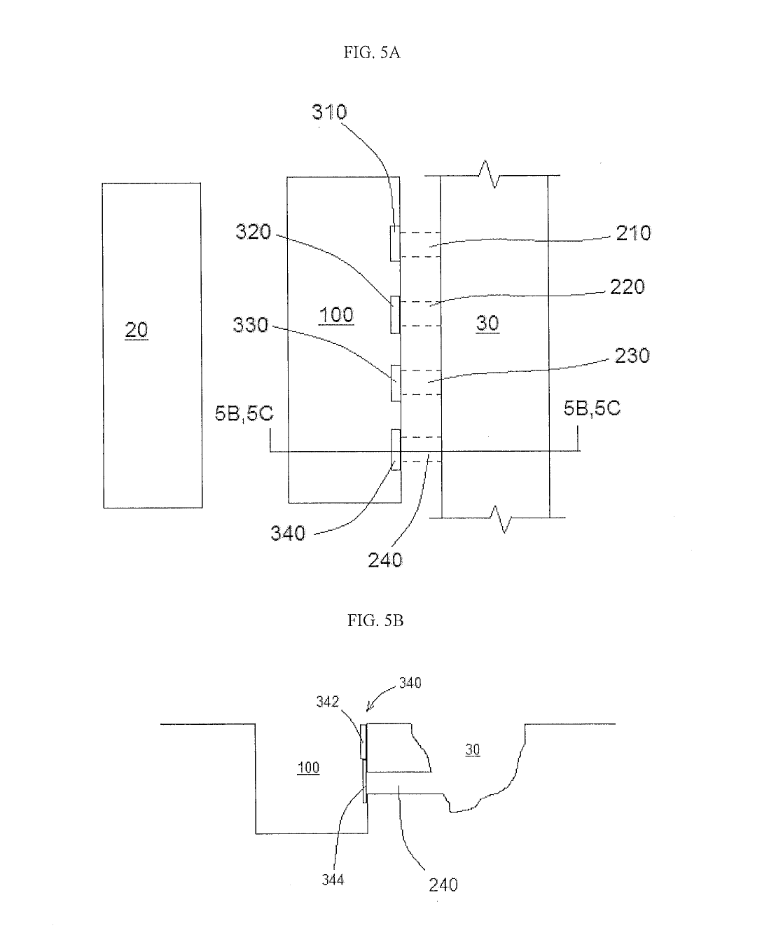

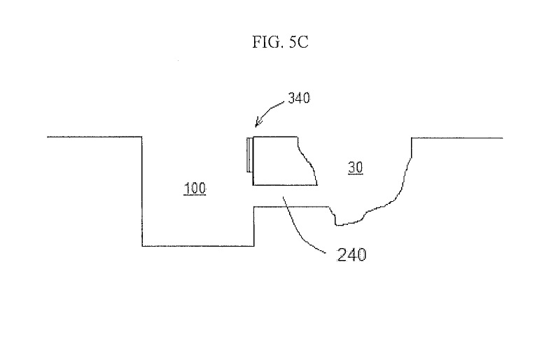

FIGS. 5A-5C illustrate a modification to the system 1000 illustrated in FIGS. 2-4. In FIGS. 5A-5C a plurality of control stations are installed to control water flowing between long pond 100 and the drainage ditch 30. For example, in the embodiment of FIGS. 5A-5C, four passages 210, 220, 230, and 240 may allow water to flow from the pond 100 to the drainage ditch 30 or from the drainage ditch 30 to the long pond 100. In order to control the flow of water between the long pond 100 and the drainage ditch 30 four control stations 310, 320, 330, and 340 may be provided to regulate the flow of water through the first, second, third, and fourth passages 210, 220, 230, and 240. For the example, the first control station 310 may control water flowing through the first passage 210, the second control station 320 may control water flowing through the second passage 220, the third control station 330 may control water flowing through the third passage 230, and the fourth control station 340 may control water flowing through the fourth passage 240.

FIGS. 5B and 5C illustrate an example of the fourth control station 340 controlling water flowing through the fourth passage 240. For example, in FIGS. 5B and 5C the fourth control station 340 includes a gate 344 (for example, a plate) configured to cover the fourth passage 240 and an actuator 342 configured to move the gate 344. In FIG. 5B, for example, the gate 344 is illustrated as covering the fourth passage 240 to prevent water from flowing between the long pond 100 and the ditch 30 via the fourth passage 240. FIG. 5C, however, illustrates the gate 344 away from the fourth passage 240 to allow water to flow between the long pond 100 and the ditch 30.

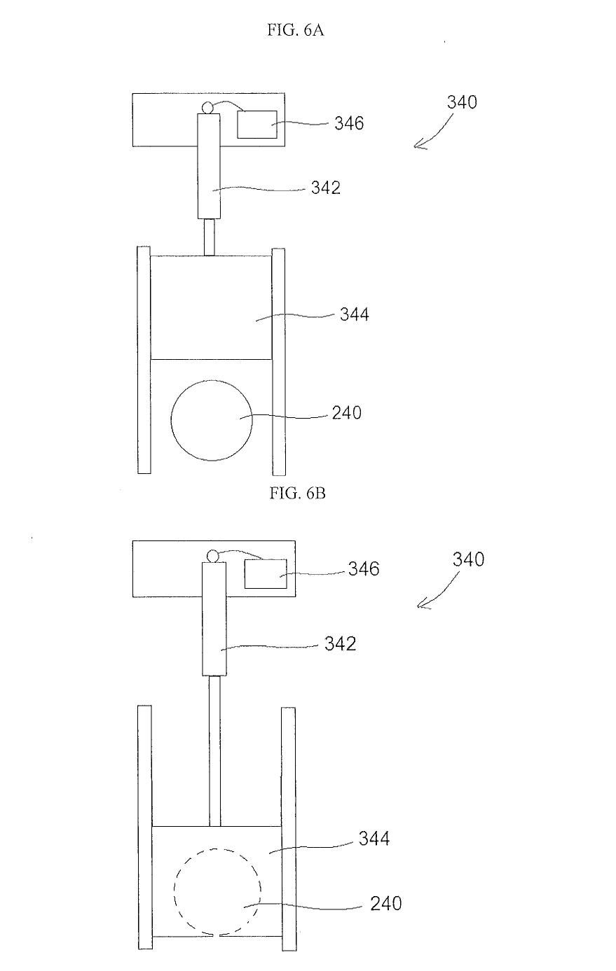

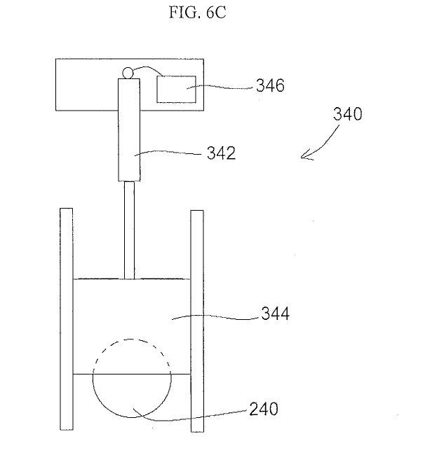

FIGS. 6A to 6C illustrate various views of the example control station 340. As shown in FIGS. 6A to 6C the example control station 340 includes a power source (not shown, but may be a battery), the actuator 342, the gate 344, and a controller 346. The controller 346 may be an electronic controller and may have a built in memory with a software program embedded therein to control the actuator 342 thereby controlling a placement of the gate 344. The controller 346 may also include an antenna for wireless communication so the controller 346 may receive data from an external source in order to control the actuator 342. In the event the controller 346 determines the passage 240 should be open to allow water to flow between the long pond 100 and the ditch 30 the controller 346 may control the actuator 342 to move the gate 344 away from the passage 240 as shown in FIG. 6A. In the event the controller 346 determines the passage 240 should be closed to prevent water from flowing between the long pond 100 and the ditch 30 the controller 346 may control the actuator 342 to move the gate 344 to cover (block) the passage 240 as shown in FIG. 6B. In the event the controller 346 determines the passage 240 should be partially open to allow for a reduced flow of water between the long pond 100 and the ditch 30 the controller 346 may control the actuator 342 to move the gate 344 to partially cover (partially block) the passage 240 as shown in FIG. 6C.

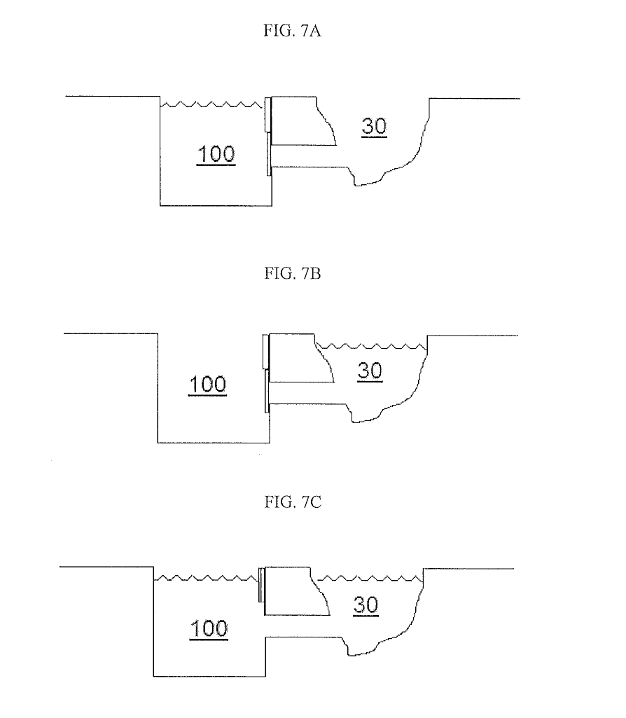

FIGS. 7A-7C illustrate various effects a control station may have on water management. In FIG. 7A, for example, the control stations are illustrated as controlling their gates to prevent water from flowing from the long pond 100 to the drainage ditch 30. In this configuration, surface water from a field 10 may flow through buffer strip 20 and into the long pond 100 where it may be stored for future use. In FIG. 7A the gates may prevent water from passing from the long pond 100 to the drainage ditch 30. In FIG. 7B the control stations are illustrated as controlling their gates to prevent water from flowing from the ditch 30 into the long pond 100. In this situation water from the ditch 30, rather than flowing into the long pond 100, may flow to a downstream point where the water may be used, stored, or simply discarded. In FIG. 7C the control stations are illustrated as controlling their gates to allow water to flow from the drainage ditch 30 to the long pond 100 or from the long pond 100 to the drainage ditch 30. Opening the passages may serve at least two purposes. For example, opening the passages 210, 220, 230, and 240 may allow for surface water to enter the long pond 100 while allowing excess water to flow to the drainage ditch 30 for removal. As such, this may prevent local flooding around the long pond 100. As a second purpose, the long pond 100 may act to receive water from the drainage ditch 30 in the event the drainage ditch 30 is being overfilled from an upstream water source. By allowing the long pond 100 to receive a portion of water from the drainage ditch 30 downstream flooding may be prevented.

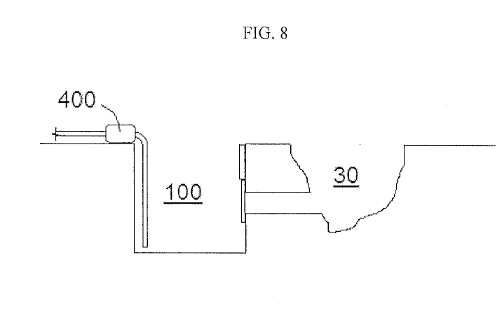

In example embodiments, the above described system may be further modified. For example, as shown in FIG. 8, a pump 400 with piping may be provided to pump water from the long pond 100. The water, for example, may be pumped to an irrigation system, for example, a sub-surface irrigation system or a surface irrigation system. Thus, the long pond 100 may function as a reservoir for water which may be used for irrigation purposes.

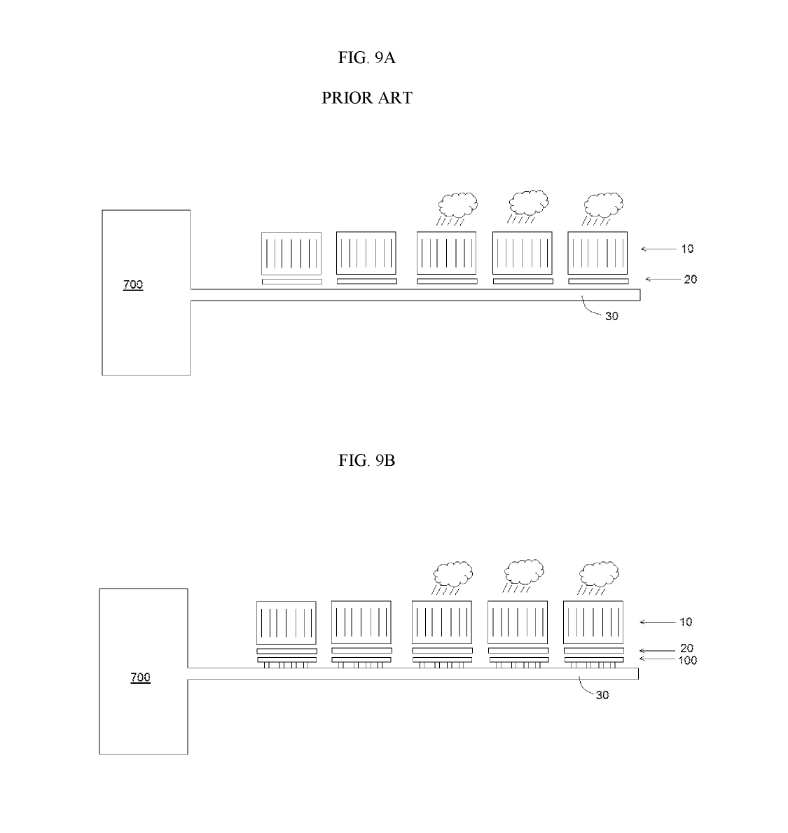

FIG. 9A illustrates a conventional layout of farm fields 10 with buffer strips 20 interposed between the farm fields 10 and a ditch 30 (which may alternatively be a canal, a stream, or even a river). In the conventional art, surface water may flow from the fields 10, through the buffer strips 20, and into the ditch 30 where the water may flow to a receiving body 700 which may be, but is not required to be, a lake or a river. In the particular example of FIG. 9A, the three rightmost fields 10 are illustrated as being subject to rain. In this particular example, the rain generally falls on the three most right hand farm fields 10 and then flows through the three right most buffer strips 20 and then into the ditch 30. The ditch 30 carries all of this water to the receiving body 700. In the event the amount of rain is high the water transferred into the receiving body 700 may be quite high and may, in fact, flood the receiving body 700.

FIG. 9B illustrates a novel layout of farm fields 10, buffer strips 20, and long ponds 100 interposed between the buffer strips 20 and a ditch 30 (which may alternatively be a canal, a stream, or even a river). In this novel layout, surface water may flow from the fields 10, through the buffer strips 20, through the long ponds 100, and into the ditch 30 where the water may flow to a receiving body 700 which may be, but is not required to be, a lake or a river. In the particular example of FIG. 9B, the three rightmost fields 10 are illustrated as being subject to rain. In this particular example, the rain generally falls on the three most right hand farm fields 10 and then flows through the three right most buffer strips 20, into the three right most long ponds 100 and then into the ditch 30. Thus, the ditch 30 may carry all of this water to the receiving body 700 or only part of the water since some of the water may be retained by the three right most long ponds 100. Also, in the event the rain is relatively heavy, the left two most long ponds may receive water from the ditch 30 further reducing an amount of water delivered to the receiving body 700. Thus, the presence of the long ponds 100 may reduce or minimize an amount of water flowing into the receiving body 700 thereby reducing a potential of flooding.

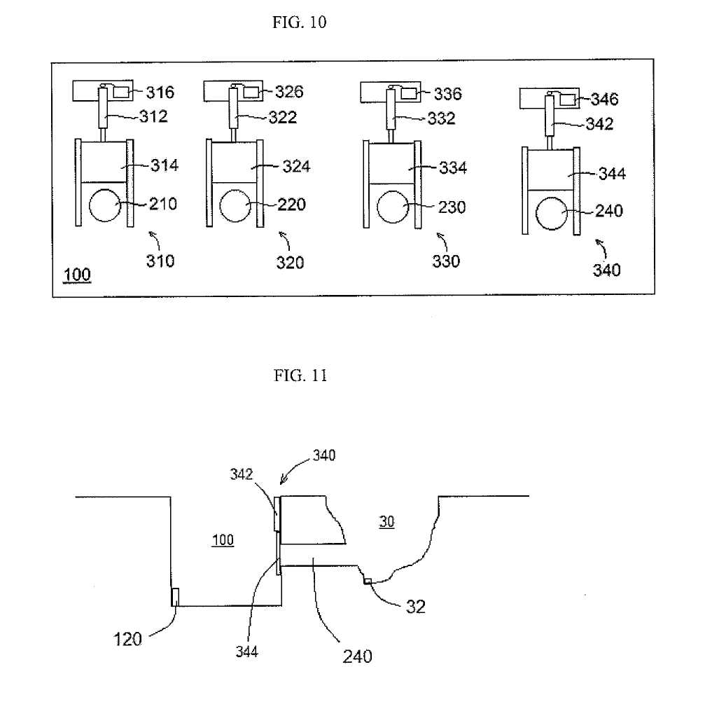

FIG. 10 is a view of a wall of the long pond 100 illustrating the first, second, third, and fourth passages 210, 220, 230, and 240 along with their respective control stations 310, 320, 330, and 340. Each of the first, second and third control stations 310, 320, and 330 may be substantially identical to the fourth control station 340. For example, the first, second and third control stations 310, 320, and 330 may include electronic controllers 316, 326, and 336 configured to control actuators 312, 322, and 332 which are configured to move gates 314, 324, and 334 which may cover or expose the passages 210, 220, and 230. The controllers 316, 326, 336 for example, may include a computer readable medium which includes an algorithm or computer program embedded therein to control their respective gates 314, 324, and 334. In example embodiments the controllers 316, 326, 336, and 346 may be programmed with swarm technology and thus may communicate amongst themselves to control how much water enters or leaves the long pond 100. For example, the first controller 316 may receive data from at least one of the second, third, and fourth controllers 326, 336, and 346 and may use this data to control a position of the gate 314. Similarly, the second controller 326 may receive data from at least one of the first, third, and fourth controllers 316 and may use this data to control a position of the gate 324. Although the above description describes the controllers 316, 326, 336, and 346 as being programmed with swarm intelligence, the invention is not limited thereto. For example, each of the controllers 316, 326, 336, and 346 have two-way telemetry and may receive and transmit control information with an outside source and may use this control information to control their respective gates 314, 324, 334, and 344.

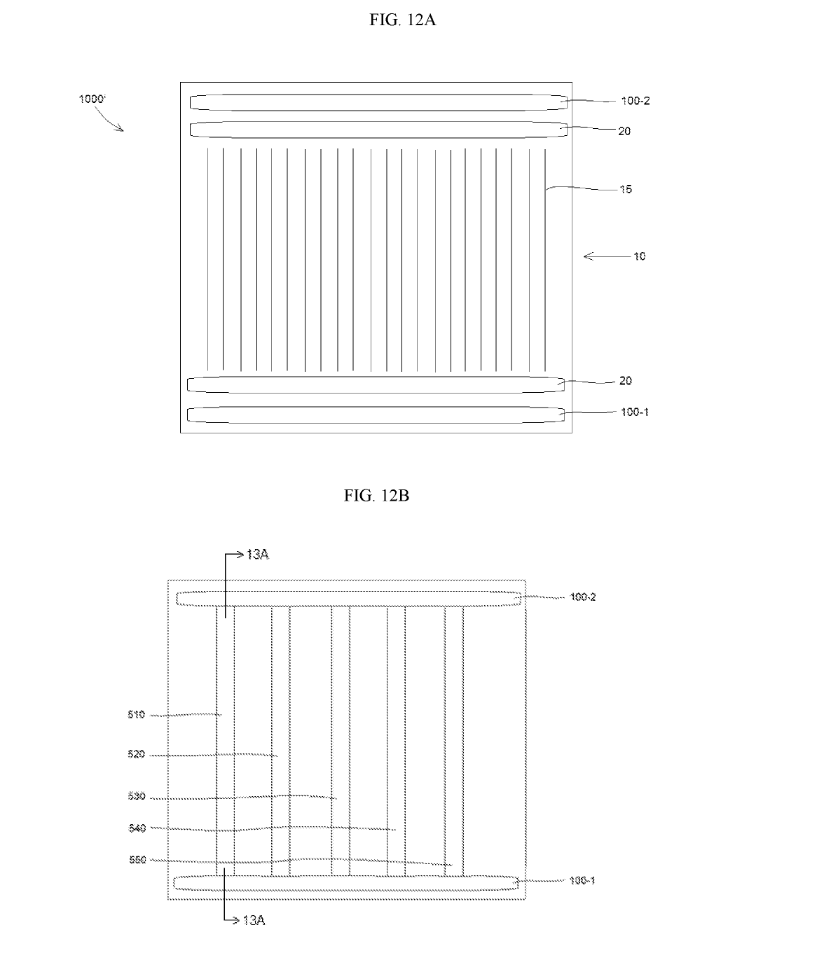

The invention is not intended to be limited by the preceding example embodiments. FIG. 11, for example, illustrates the system 1000 further including a first sensor 120 in the long pond 100 and a second sensor 32 in the drainage ditch 30. The first sensor 120 may, for example, be a pressure sensor, a float sensor, a contact sensor, a noncontact sensor, or any other type of sensor which may provide data indicating how much water is in the long pond 100. Similarly, the second sensor 32 may be a sensor which may generate data indicative as to how much water is in or flowing through the ditch 30. For example, the second sensor 32 may be a pressure sensor, a float sensor, a contact sensor, a noncontact sensor, or any other type of sensor which may provide data indicating how much water is in and/or flowing through the drainage ditch 30. In the nonlimiting example of FIG. 11, each of the sensors 120 and 32 may send data either wirelessly over a wire to at least one of the control stations of the plurality of control stations or may send data to an external controller that controls the control stations. The control station and/or stations receiving the data or the controller controlling the controls stations may use this data to determine whether the gates of the control stations should be positioned to prevent water from flowing through the plurality of passages or allow water to flow through the plurality of passages and then control the gates to either allow water to flow through the plurality of passages or prevent water from flowing through the plurality of passages. For example, if the level of water in the ditch 30 is relatively high and the level of water in the long pond 100 is relatively low, the controllers 316, 326, 336, and 346 may control the gates 314, 324, 334, and 344 to allow water to flow from the drainage ditch 30 to the long pond 100 via passages 210, 220, 230, and 240. On the other hand, if the level of water in the long pond 100 is relatively high (for example, the long pond is filled to capacity) the controllers 316, 326, 336, and 346 may control the gates 314, 324, 334, and 344 to prevent water from flowing from the drainage ditch 30 to the long pond 100 to prevent the long pond 100 from flooding.

Thus far example embodiments have illustrated example systems in which multiple long ponds 100 may be used to prevent flooding, store water, and improve both wildlife habitat and water quality. In some examples, for example, the systems illustrated in FIGS. 9A and 9B, several long ponds 100 may be placed in series in order to achieve the aforementioned goals. However, this is not intended to limit the invention. For example, FIGS. 12A and 12B illustrate another system 1000′ which includes two long ponds 100-1 and 100-2 placed in parallel with each other. More specifically, FIGS. 12A and 12B illustrate a system 1000′ having a farm field 10 upon which plants 15 are grown. In this particular nonlimiting example embodiment, the farm field 10 may include a first long pond 100-1 and a second long pond 100-2. Between the plants 15 and the first and second long ponds 100-1 and 100-2 may be buffer strips 20 which may act to filter out contaminants from the field 10 as was previously described. However, as in the previous embodiments, the buffer strips 20 are not required to implement the inventive concepts disclosed herein and the buffer strips 20 may be omitted from the system 1000′.

FIG. 12B illustrates part of the system 1000′. As shown in FIG. 12B, the system 1000′ may include a plurality of passages 510, 520, 530, 540, and 550 between the first long pond 100-1 and the second long pond 100-2. The passages 510, 520, 530, 540, and 550 may allow for fluid communication between the first long pond 100-1 and the second long pond 100-2. For example, the plurality of passages 510, 520, 530, 540, and 550 may be pipes or tubes connecting the first long pond 100-1 to the second long pond 100-2. In the alternative, the passages 510, 520, 530, 540, and 550 may be configured in a manner similar to French drains to direct surface and ground water to the long ponds 100-1 and 100-2. It is understood that although FIG. 12B illustrates five (5) passages 510, 520, 530, 540, and 550 connecting the first long pond 100-1 to the second long pond 100-2 the number of passages may be more than five passages or less than five passages (for example, only a single passage, two passages, three passages, or four passages) as the total number of passages shown in the embodiment of FIGS. 12A and 12B are for purposes of illustration and are not meant to limit the invention.

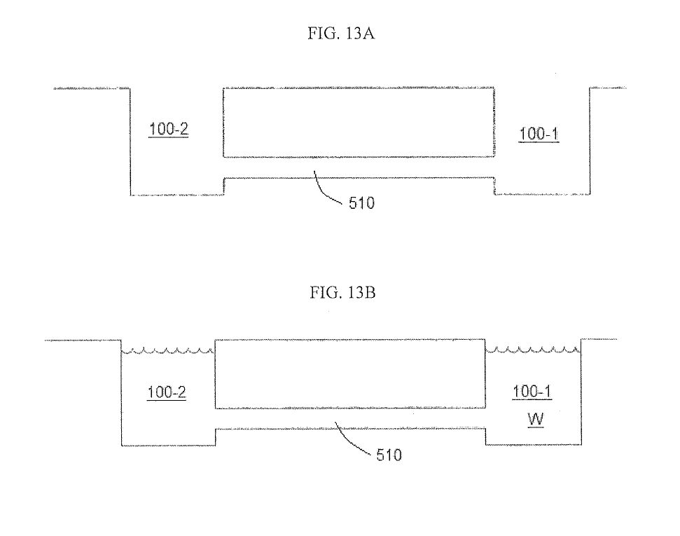

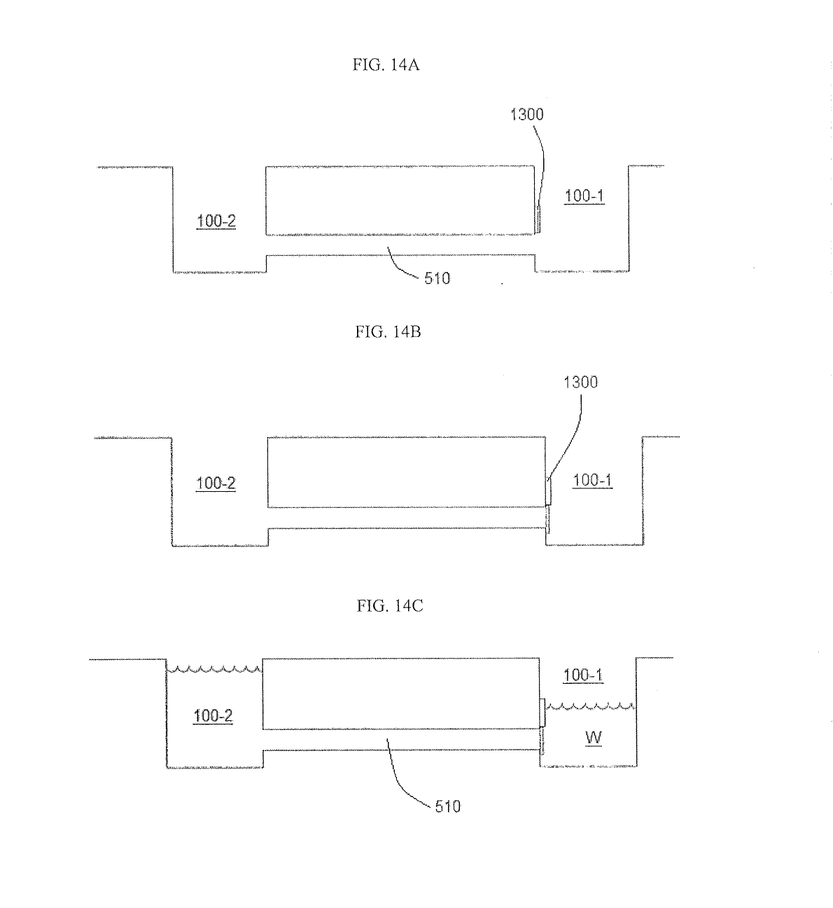

FIGS. 13A and 13B illustrate a cross section taken through the first passage 510 of FIG. 12B. As shown in FIGS. 13A and 13B, a liquid, for example water W, may flow between the first long pond 100-1 and the second long pond 100-2. An advantage of having multiple long ponds in a field is that water may be located at several places rather than stored in a single location and pumped to a location distant from the single long pond.

FIGS. 14A-14C show a modification of the system 1000′. Like the previously described systems, system 1000′ may further include control stations arranged to control a flow of water between the first and second long ponds 100-1 and 100-2. Although FIGS. 14A-14C illustrate only one control station 1300 controlling a flow of water through the first passage 510, it is understood similar control stations may be arranged adjacent the second, third, fourth and fifth passages 520, 530, 540, and 550. In example embodiments, the control station 1300 may resemble the control station 340 and thus a detailed description thereof is omitted from the sake of brevity, however, as shown in FIGS. 14A-14C it is worth noting the control station 1300 may prevent water from flowing from the first long pond 100-1 to the second long pond 100-2 or from the second long pond 100-2 to the first long pond 100-1 (as shown in FIGS, 14B and 14C) or allow water to flow between the first long pond 100-1 and the second long pond 100-2 as shown in FIG. 14A. Thus, in this particular nonlimiting example embodiment, water may be stored in the second long pond 100-2 even if water is removed from the first long pond 100-1 or may be removed from the second long pond 100-2 when water is removed from the first long pond 100-1.

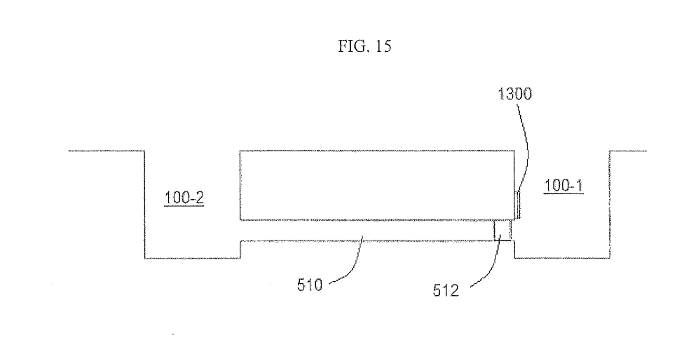

FIG. 15 illustrates another modification to the previously described systems. As shown in FIG. 15, the first long pond 100-1 and the second long pond 100-2 may be in fluid communication with one another via the first passage 510 and the flow of water between the first and second long ponds 100-1 and 100-2 may be controlled by the control station 1300. However, in the embodiment of FIG. 15 a pump 512 may be provided to promote a flow of water from either the first long pond 100-1 to the second long pond 100-2 or from the second long pond 100-2 to the first long pond 100-1. For example, if it is desired to store the water available in the first long pond 100-1 into the second long pond 100-2 the pump may promote a movement of water from the first long pond 100-1 to the second long pond 100-2.

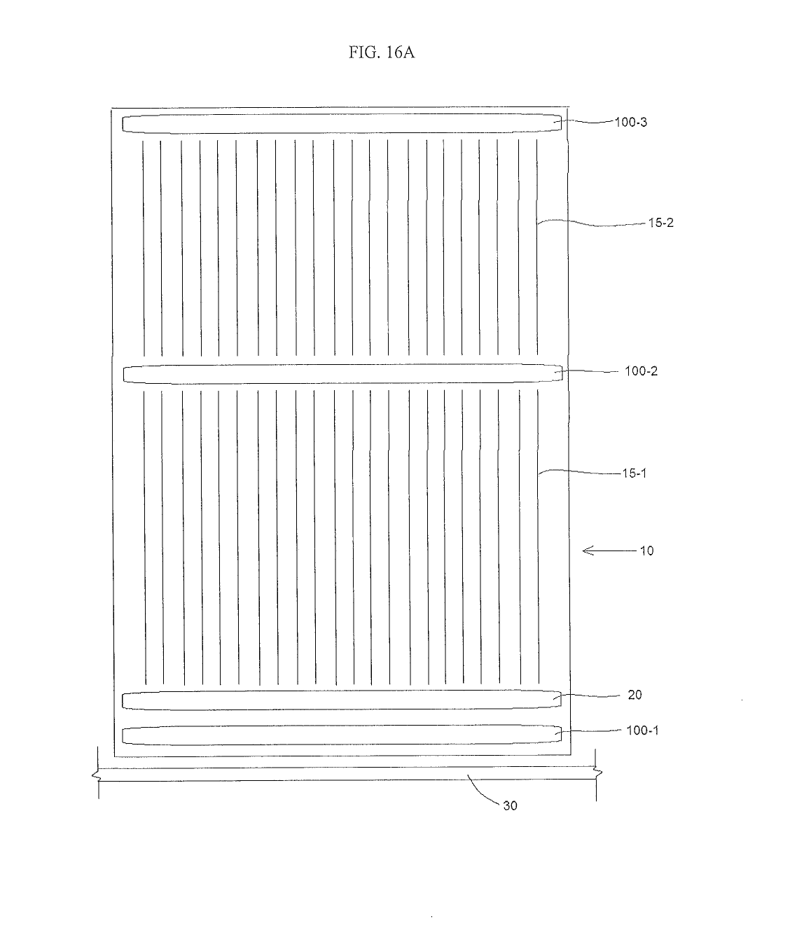

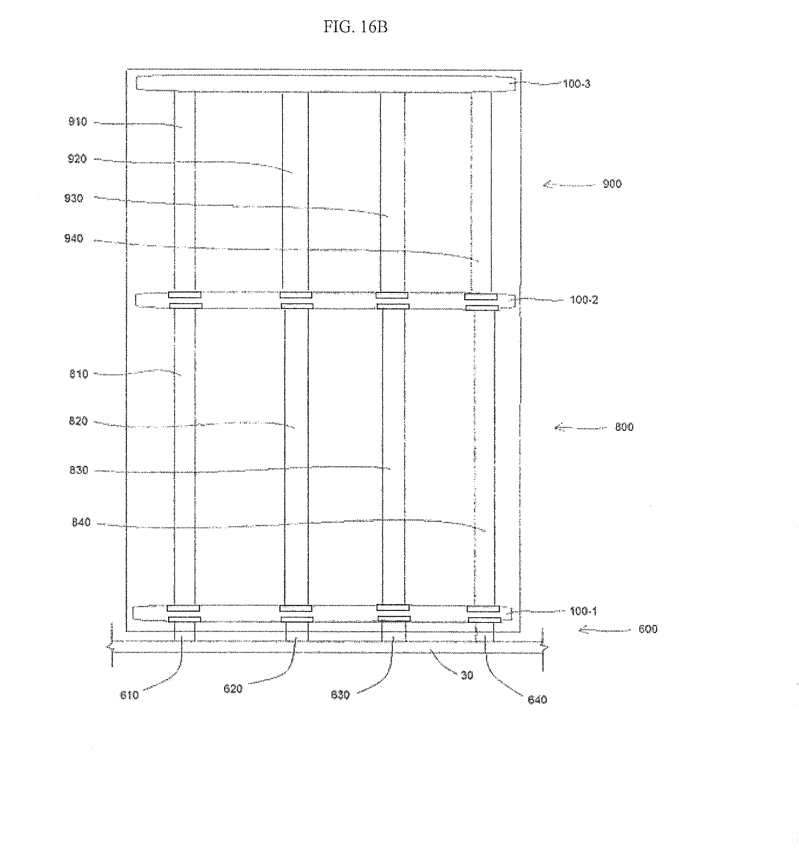

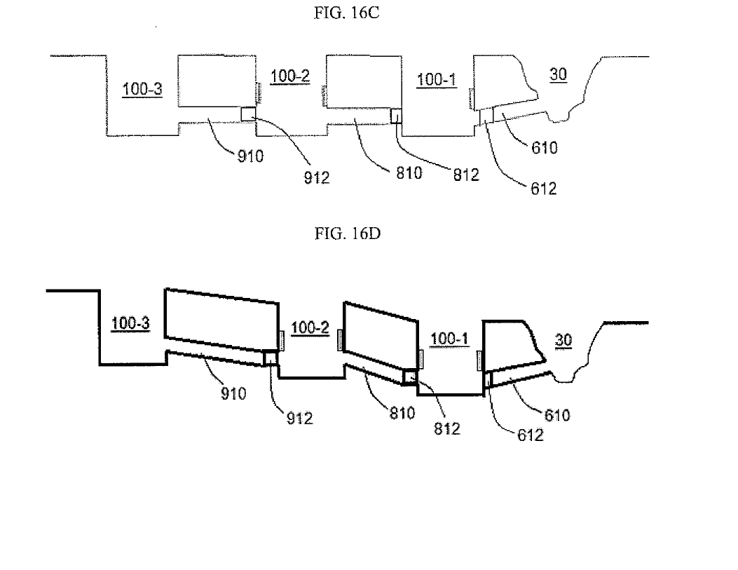

FIG. 16A illustrates another example system in accordance with example embodiments and FIG. 16B illustrates various elements of the system of FIG. 16A. As shown in FIG. 16A, the system may include a farm field 10 with multiple long ponds. More specifically, the nonlimiting example of FIG. 16 includes a first long pond 100-1, a second long pond 100-2, and a third long pond 100-3. Although the example of FIG. 16 illustrates a farm field 10 with three long ponds 100-1, 100-2, and 100-3, it is understood the number of long ponds is meant for purposes of illustration rather than limitation as the system of FIG. 16A may include only two long ponds or more than three long ponds. In example embodiments a drainage ditch 30 may be arranged near the first long pond 100-1 and may be configured to receive and/or provide water to the first long pond 100-1. Though not required, the system of FIG. 16A may also include buffer strips near the long ponds. For example, FIG. 16A is illustrated as having a buffer strip 20 near the first long pond 100-1, however, similar buffer strips may also be placed near the second and/or third long ponds 100-2 and 100-3.

FIG. 16B illustrates various elements of the system illustrated in FIG. 16A. As shown in FIG. 16B the first long pond 100-1 may be connected to the ditch 30 by a first plurality of passages, the first long pond 100-1 may be connected to the second long pond 100-2 by a second plurality of passages, and the second long pond 100-2 may be connected to the third long pond 100-3 by a third plurality of passages. In example embodiments, the first plurality of passages may be comprised of a first passage 610, a second passage 620, a third passage 630, and a fourth passage 640. The second plurality of passages may be comprised of a fifth passage 810, a sixth passage 820, a seventh passage 830, and an eighth passage 840. The third plurality of passages may be comprised of a ninth passage 910, a tenth passage 920, an eleventh passage 930, and a twelfth passage 940. As shown in FIG. 16B, various control stations may provided to control flows of water between the drainage ditch 30 and the first long pond 100-1, between the first long pond 100-2 and the second long pond 100-2 and between the second long pond 100-2 and the third long pond 100-3. In example embodiments, the control stations of FIG. 16B may resemble the previously described control station 340, as such, a detailed description thereof is omitted for the sake of brevity. As in the previous examples, the passages 610, 620, 630, 640, 810, 820, 830, 840, 910, 920, 930, and 940 may be, but are not required to be, pipes or any other structure which may transfer water from one location to another.

FIGS. 16C and 16D illustrates alternative cross-sections taken through line 16C-16C of FIG. 16B. As shown in FIG. 16C, the long ponds are well suited to manage water on farmland which is relatively flat, however, as shown in FIG. 16D, the long ponds are also well suited to manage tiered farmlands as well. In FIGS. 16C and 16D it is understood that pumps may be arranged near or in the passages to facilitate water movement from and/or to the long ponds 100-1, 100-2, and 100-3 to the drainage ditch 30. For example, in the embodiment of FIG. 16D water in the ditch 30 may flow under gravity to the first long pond 100-1 and this water may be pumped to the second long pond 100-2 via pump 812, and from the second long pond 100-2 to the third long pond 100-3 via a pump 912. Similarly, water may flow from the third long pond 100-3 to the second long pond 100-2 under gravity, from the second long pond 100-2 to the first long pond 100-1 under gravity, and may be pumped to the drainage ditch via pump 612.

Although FIGS, 16A-16D only show pumps residing in or near passages 610, 810, and 910 it is understood that pumps may also reside in or near passages 620, 630, 640, 820, 830, 840, 920, 930, and 940 to facilitate water transfer.

As in the previous examples, the long ponds 100-1, 100-2, and 100-3 may be used to manage and minimize the impacts of excessive rain on flooding. For example, in the event each of the long ponds 100-1, 100-2, and 100-3 are filled to capacity and heavy rain is predicted to occur in the very near future, the long ponds 100-1, 100-2, and 100-3 may be drained ahead of the rain to enable them to receive water. Shedding water in advance of a heavy rain may enable the long ponds 100-1, 100-2, and 100-3 to receive water either directly from fields or from the drainage ditch 30 to reduce both local flooding or downstream flooding. This may be accomplished by configuring each of the control stations to receive weather forecast information and then control the pumps and gates associated with the systems to manage water levels in the long ponds.

While example embodiments have been particularly shown and described with reference to example embodiments thereof, it will be understood by those of ordinary skill in the art that various changes in form and details may be made therein without departing from the spirit and scope of the invention.

1. A system for managing water comprising:
a long pond having a means to receive water from a drainage ditch.

2. The system of claim 1, wherein the means to receive water includes at least one passage extending from the long pond to the drainage ditch.

3. The system of claim 2, wherein the at least one passage is at least one pipe.

4. The system of claim 3, wherein the at least one pipe extends from the long pond to the drainage ditch.

5. The system of claim 3, further comprising:
a first control station, wherein the at least one pipe includes a first pipe and the first control station includes a first gate configured to regulate water flowing through the first pipe.

6. The system of claim 5, wherein the first control station further includes a first electronic controller configured to control the first gate, the first electronic controller being configured to receive data from a first external source and use that data to control the first gate.

7. The system of claim 6, further comprising:
a second control station, wherein the at least one pipe includes a second pipe and the second control station includes a second gate configured to regulate water flowing through the second pipe.

8. The system of claim 7, wherein the second control station further includes a second electronic controller configured to control the second gate, the second electronic controller being configured to receive data from a second external source and use that data to control the second gate.

9. The system of claim 8, wherein the first external source is the second control station and the second external source is the first control station.

10. The system of claim 8, wherein each of the first and second pipes extend from the long pond to the ditch.

11. The system of claim 1, further comprising:
a pump configured to pump water out of the long pond.

12. The system of claim 11, further comprising:
a sub-irrigation system, wherein the pump is configured to pump water to the sub-irrigation system.

13. The system of claim 11, further comprising:
an irrigation system, wherein the pump configured to pump water to the irrigation system.

14. The system of claim 11,
wherein the pump is configured to pump water to the drainage ditch.

15. The system of claim 10, further comprising:
a buffer strip, wherein the long pond is between the buffer strip and the drainage ditch.

16. The system of claim 1, further comprising:
a control station, wherein the means to receive water from the drainage ditch is a pipe configured to directly flow water from the drainage ditch to the long pond and the control station is arranged at an end of the pipe to control the flow of water.

17. The system of claim 16, wherein the control station includes a gate and an actuator to move the gate to restrict the flow of water.

18. The system of claim 15, wherein the control station further includes an electronic controller with a built in memory having a software program embedded therein to control the actuator.
